(19) United States
(12) Patent Application Publication
(10) Pub. No.: US 2008/0230104 A1
(43) Pub. Date: Sep. 25, 2008

(54) Cubicle

(76) Inventors: Laurence John Potter, West Midlands (GB); Pamela Potter, West Midlands (GB)

Correspondence Address: BROOKS KUSHMAN P.C., 1000 TOWN CENTER, TWENTY-SECOND FLOOR, SOUTHFIELD, MI, 48075, US

(21) Appl. No.: 10/598,646

(22) PCT Filed: Mar. 10, 2005
(86) PCT No.: PCT/GB05/00925

§ 371 Date: Sep. 7, 2006

(30) Foreign Application Priority Data
Mar. 10, 2004 (GB) 0405351.8

(51) Int. Cl. E04H 15/06; B60P 3/41

(52) U.S. Cl. 135/88.14; 296/24.39; 296/1.07

(57) ABSTRACT

A temporary cubicle device can be either fully or partly free-standing or have a part thereof attached to a vehicle. In its free-standing state it is foldable from a stowed state to an erected state by manipulating a foldable support frame which has a pair of support arms pivotally connected to a pair of main link arms which are pivotally connected at their adjacent ends respectively to part of the support frame. The material of the cubicle device is attached to the support arms, whilst in the erected state of the cubicle device a strut formed by links maintains the main link arms unfolded and thus the support arms spaced apart and parallel.

This invention relates to a temporary cubicle which can be readily erected and subsequently disassembled, and also to a vehicle incorporating a temporary cubicle.

There are, in the U.K., approximately 120,000 people who suffer from an illness known as Irritable Bowel Disease (IBD). Common to such sufferers is the need to visit a toilet frequently and urgently. Whilst schemes exist to provide wider access to toilets through special key arrangements etc., the provision of public toilets is, in practice, very inadequate.

Moreover, in the wider context of healthy people, there can arise situations where the availability of an emergency toilet would be beneficial, particularly where children or elderly people are involved. Such situations might arise when visiting remote beauty spots where there are no toilets, in long tailbacks on motorways, vehicle breakdowns or as a result of temporary illnesses. Finally, the cubicle alone of such an emergency toilet could be of use to swimmers, surfers, etc. who need to change in a public place.

An object of the invention is to provide a temporary cubicle, and also a vehicle incorporating same, in a convenient and effective manner.

According to a first aspect of the invention there is provided a vehicle having attached to a part thereof a temporary cubicle device which is normally in a first, stowed state in or on the vehicle, but which upon manipulation by a user can assume an assembled state in which at least a part thereof is at the exterior of the vehicle.

In one embodiment, the vehicle is of hatchback form and the device is normally stowed in the boot thereof in its first state. Opening of the rear door or tailgate of the hatchback vehicle automatically at least partly assembles the device. Preferably the device incorporates an upper support frame which, when said rear door or tailgate is fully open, can be manually lifted to lie horizontal. Conveniently said frame defines the shape of the assembled cubicle and in one embodiment it is square or rectangular. Depending from the frame is non-transparent material, and advantageously said material extends, in use, to the ground when the cubicle is fully assembled/erected. The support frame is held horizontal by a spring and catch mechanism. In its assembled state, the material of the cubicle has a zipped or ‘Velcro’® opening to allow access into the cubicle. Desirably a toilet seat is attached to a floor of the vehicle boot, and more desirably the toilet seat can be moved from a first stowed position where it is wholly received in the boot, to a second, in use, position where it is within the assembled cubicle. The seat can be pivoted from its first to its second position.

In a second embodiment, the device is normally stowed on the roof of the vehicle in its first state. Preferably it is mounted in the manner of a conventional roof rack. The stowed device may be locked against unauthorised operation. The device incorporates a linkage allowing a main upper canopy part thereof to be drawn forwards and upwards to a position where it lies at the exterior of one side of the vehicle. Preferably when the device is pulled from its stowed state it moves over top dead centre, so that when the canopy part is at the exterior of said one side of the vehicle, it is in a stable, horizontal position. Desirably with the canopy part in this position, operation of a catch releases from the underside of the canopy part a lower side part of the device, which depends from the canopy part at said side of the vehicle. Conveniently a toilet seat is stowed at said lower side part. Once the canopy part and lower side parts of the device are positioned as described above, non-transparent material attached to the canopy part can be released from its folded state so as to depend therefrom to reach the ground, preferably in the manner of lowering a window blind. Access to the now assembled cubicle device is via a zipped or ‘Velcro’® opening in the material.

According to a second aspect of the invention there is provided a temporary cubicle device comprising a foldable support frame having attached to part thereof foldable non-transparent material, the support frame and material being movable between a first, folded state for stowage of the device, and a second, unfolded state in which the unfolded support frame defines at least part of the shape of the cubicle device in its assembled state in which said material is unfolded.

Preferably the support frame includes a linkage having a pair of support arms to which said material is attached. Desirably when said support frame is unfolded, the support arms are automatically moved to lie normal to a main part of the support frame.

Conveniently the assembled cubicle device is square or rectangular in plan, with a pair of opposite sides thereof being formed by said material depending from said support arms which are horizontal, parallel and spaced apart.

In another embodiment the support frame includes a foldable linkage which, in its erected state provides respective upper and lower pairs of parallel support arms to which said material is attached. Preferably in its erected state the linkage has at each of its upper and lower ends a pair of link arms carrying one of said pairs of support arms normal thereto, the link arms being foldable towards one another, in use, and sliding along a support member of the support frame when the linkage is moved to its folded state. The support member is foldable about its centre so that in the folded state of the support frame the two linkages nest aside each other, as do the two halves of the support member. Desirably respective upper and lower toggles are actuatable in the erected state of the support frame to rigidify it, or are actuatable as part of the erection process to rectify the erected support frame.

The material is conveniently of waterproof material, such as tent fabric. It can be fitted at an opening thereof with a double-sided zip or ‘Velcro’® and is preferably washable. Primarily the top of the cubicle device, but also possibly the bottom thereof, is advantageously fitted, in use, with respective disposable covers held in place with press studs or the like. The upper cover may be translucent to provide light to the cubicle device, and keeps rain off a user of the cubicle device. The more optional lower cover provides an ‘anchor’ weight to steady the device in winds, and it also allows a user's feet and clothes to be kept clean and dry if the device is used in wet or muddy conditions. Once dirty, the lower cover, or groundsheet, can be disposed of and a new one readily fitted.

Whilst the cubicle device can be free-standing, it can be supported by a structure, preferably a vehicle. In such a case, the support frame preferably includes means for temporary engagement with the structure. Where the structure is a vehicle, the support frame desirably includes one or both of a stabilising arm for engaging the vehicle roof and a suction cup for engaging the vehicle window. Conveniently the support frame includes two spaced stabilising arms, each of which is adapted mechanically to engage a vehicle roof ‘well’ or a vehicle roof bar. Desirably each stabilising arm has its end rotatable to select a magnetic engagement means instead. Moreover the stabilising arms could be replaced by a main roof suction unit, for example, instead of a magnetic fixing, for aluminum bodies.

The invention will now be described, by way of example, with reference to the accompanying drawings, in which:

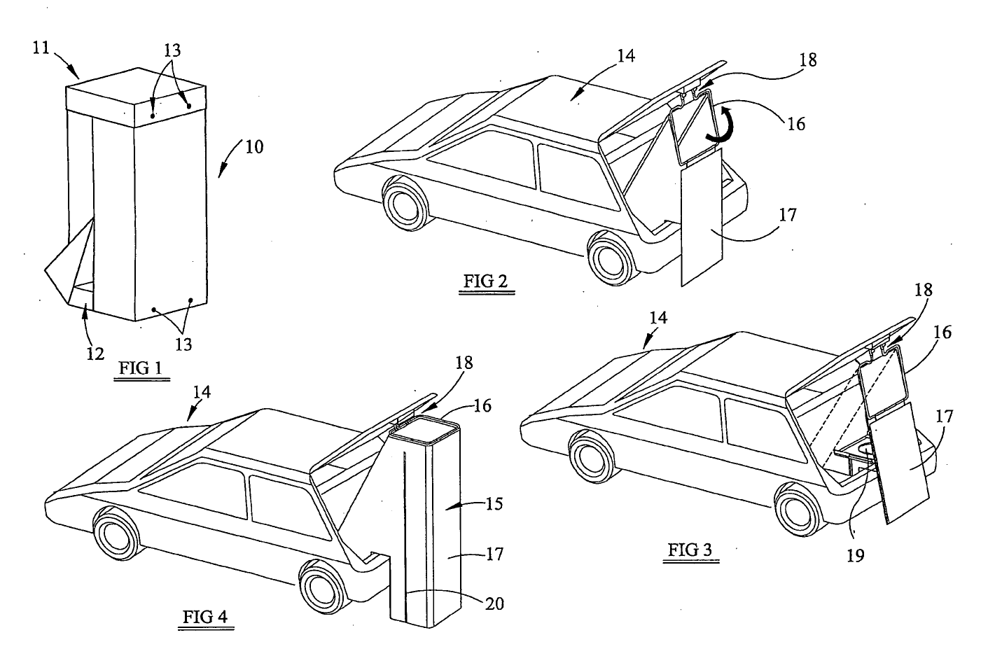

FIG. 1 is a perspective view of a cubicle device of one aspect of the invention,

FIG. 2 is a perspective view of a vehicle of another aspect of the invention with a cubicle device thereof partly assembled,

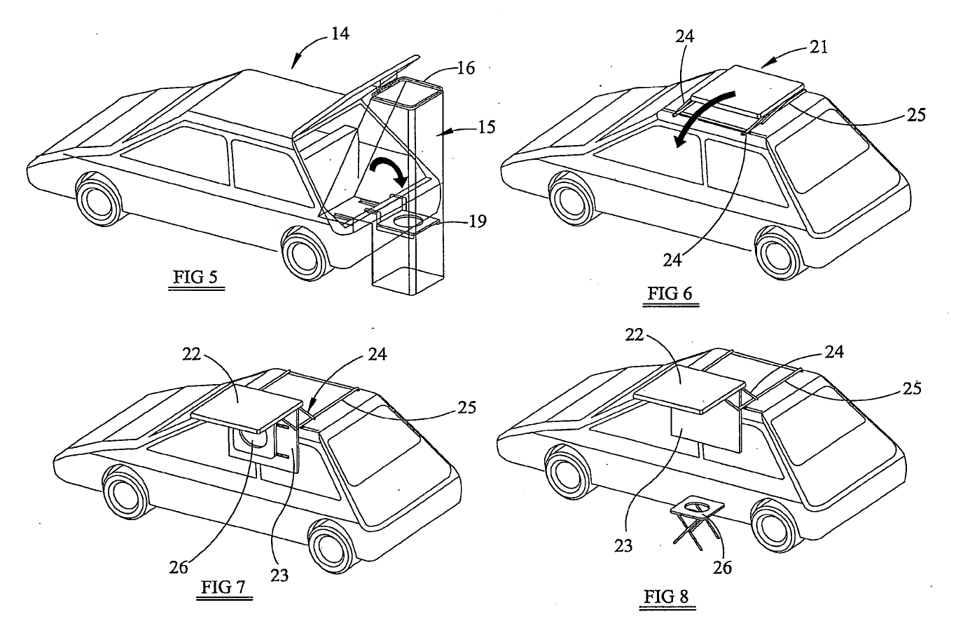

FIG. 3 is a view like FIG. 2, showing a toilet seat stowed in the vehicle,

FIG. 4 is a view like FIG. 2, showing the cubicle device assembled,

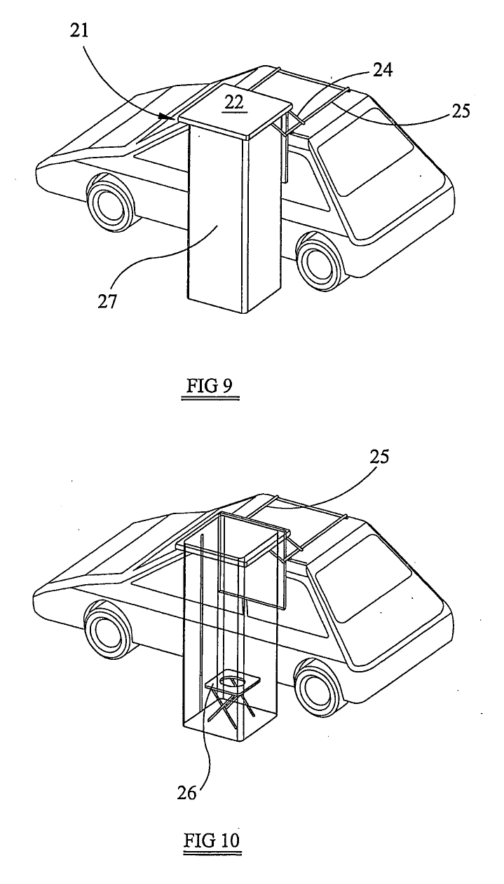

FIG. 5 is a view like FIG. 3, but with the cubicle device assembled and the toilet seat in its ‘in use’ position,

FIG. 6 is a perspective view of another embodiment of a vehicle of said another aspect of the invention,

FIG. 7 is a view like FIG. 6 showing the cubicle device partly assembled,

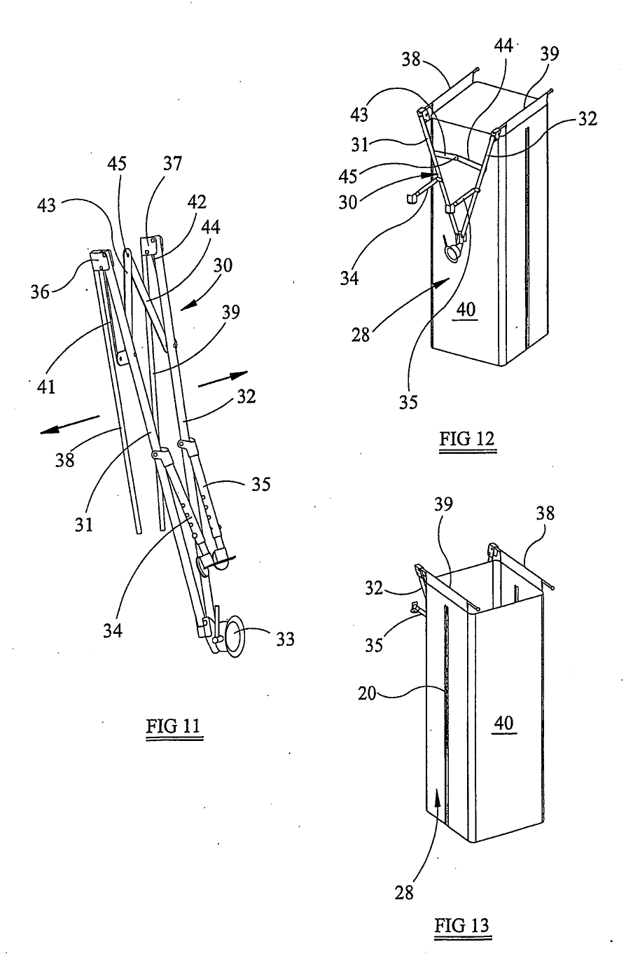

FIG. 8 is a view like FIG. 7, showing a toilet seat in position for full assembly of the cubicle device,

FIG. 9 is a view like FIG. 8, but showing the cubicle device fully assembled,

FIG. 10 is a view like FIG. 9, but showing the interior of the assembled cubicle device,

FIG. 11 is perspective view of a support frame of the cubicle device in its folded state,

FIG. 12 is a rear perspective view of an assembled cubicle device with its support frame unfolded,

FIG. 13 is a view like FIG. 12 from one side,

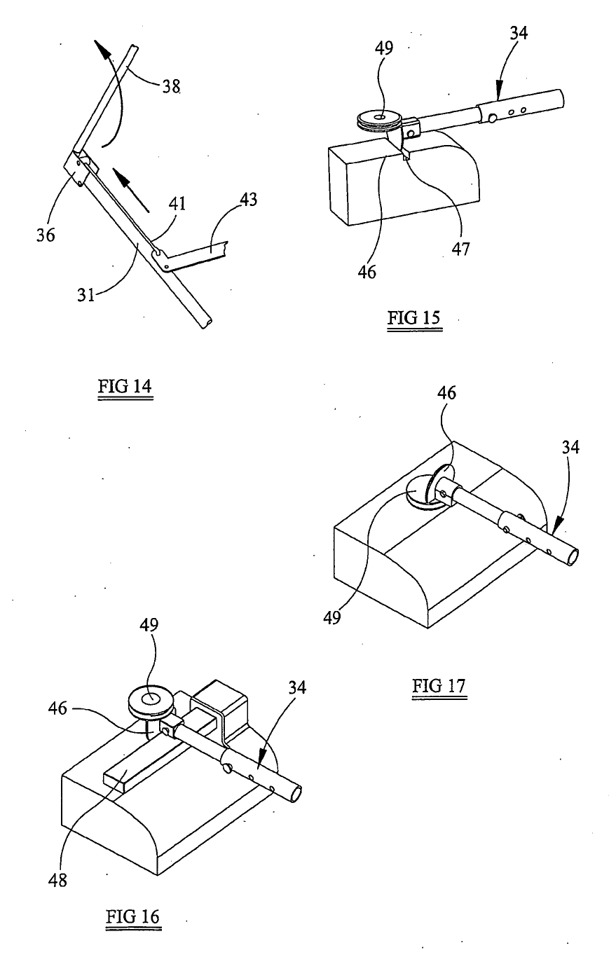

FIG. 14 is a view of part of a linkage of the support frame of FIG. 11,

FIGS. 15 to 17 are respective views of the engagement of a support arm of the support frame with a vehicle roof,

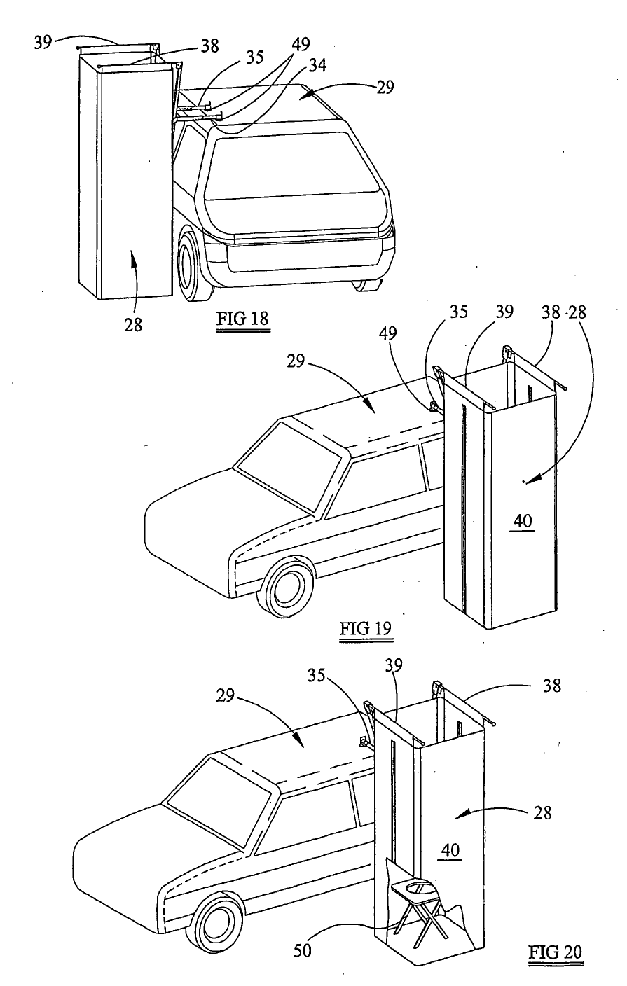

FIGS. 18 and 19 are perspective views of respective opposite sides of the assembled cubicle device of FIGS. 12 and 13 temporarily attached to a vehicle,

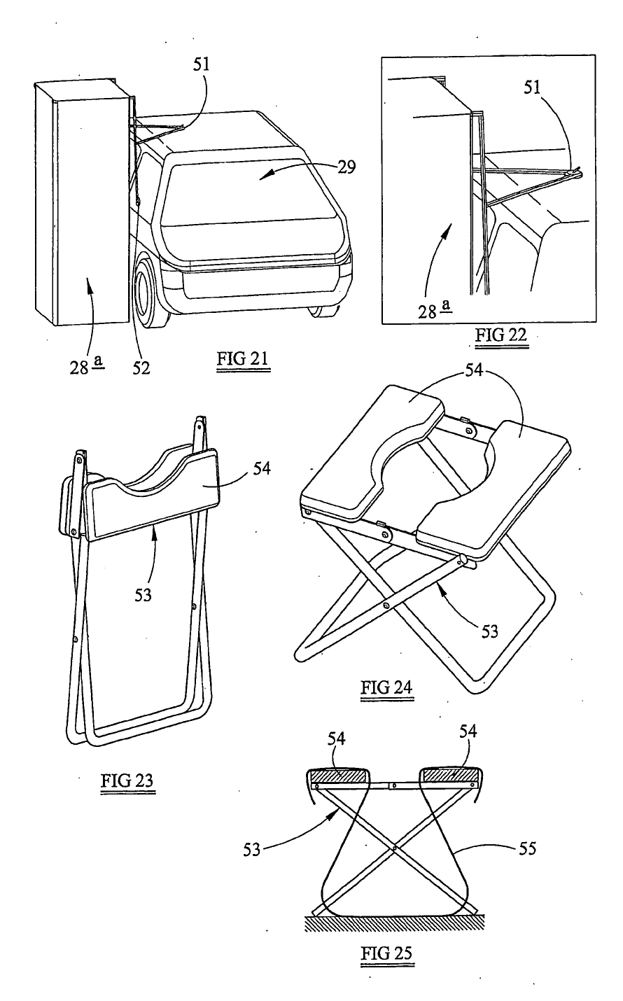

FIG. 20 is a view like FIG. 19, showing part of the assembled cubicle device cut away to show a toilet seat therein,

FIG. 21 is a view like FIG. 18, but showing different means of attaching the cubicle device to the vehicle roof,

FIG. 22 is a detail of the different attachment means of FIG. 21,

FIG. 23 is a perspective view of a toilet seat for use in a cubicle device of the invention, in its folded state,

FIG. 24 shows the seat of FIG. 25 in its unfolded state,

FIG. 25 is a schematic side view showing a waste bag used with the seat of FIG. 24,

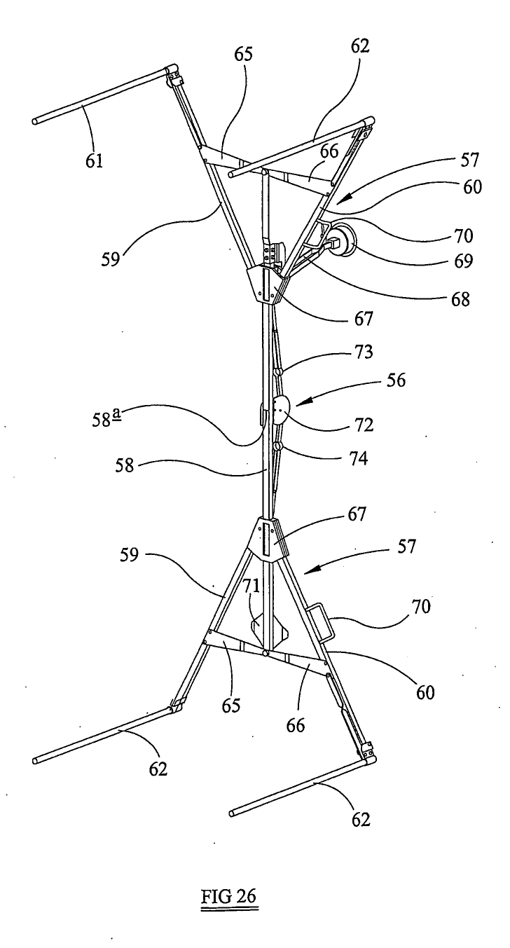

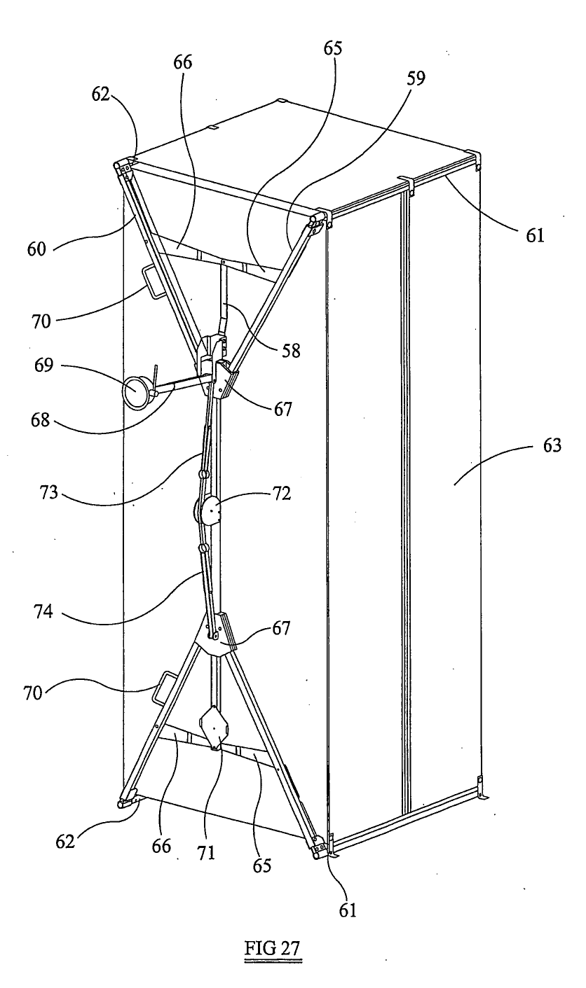

FIG. 26 is a perspective view from one side of a further support frame for a cubicle device of said one aspect of the invention,

FIG. 27 is an opposite perspective view of the further support frame, shown as part of the cubicle device of said one aspect of the invention,

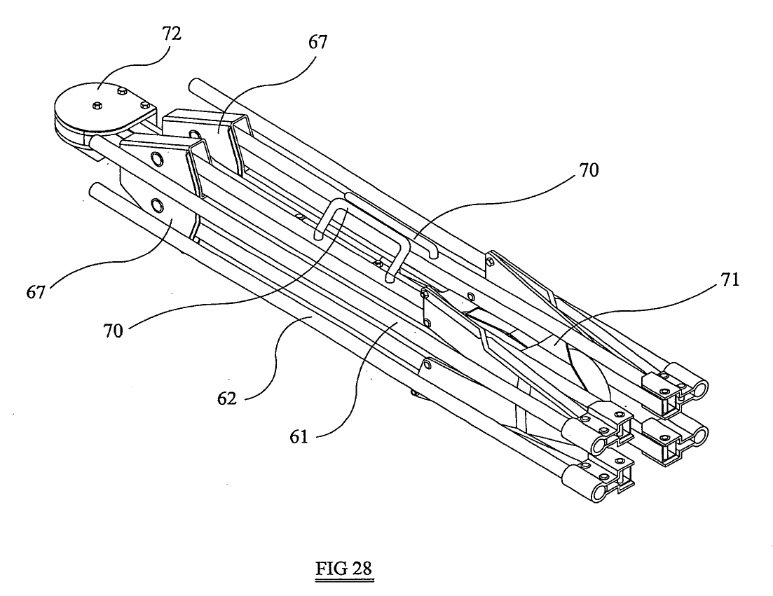

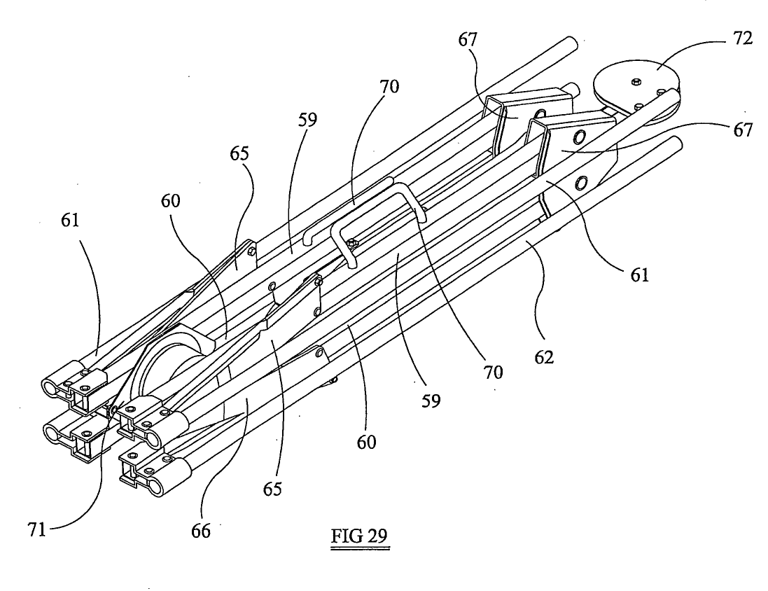

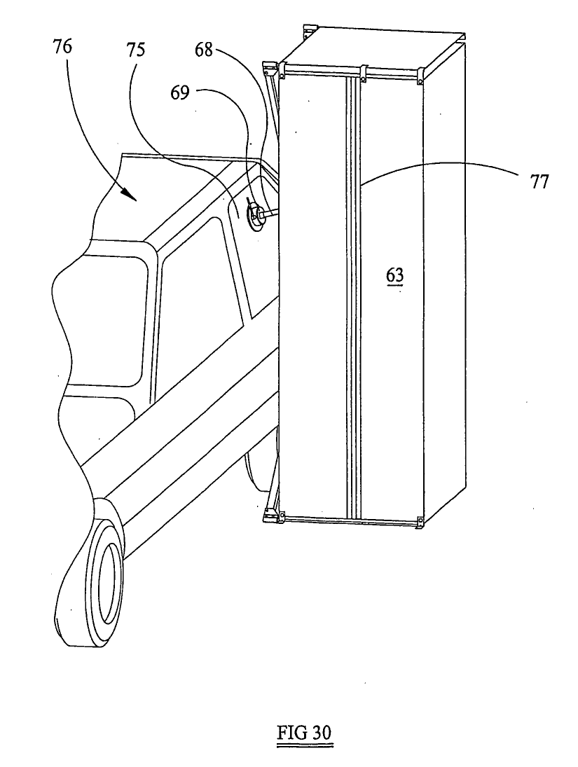

FIG. 28 is a perspective view from one side of the support frame of FIG. 26 in a folded condition,

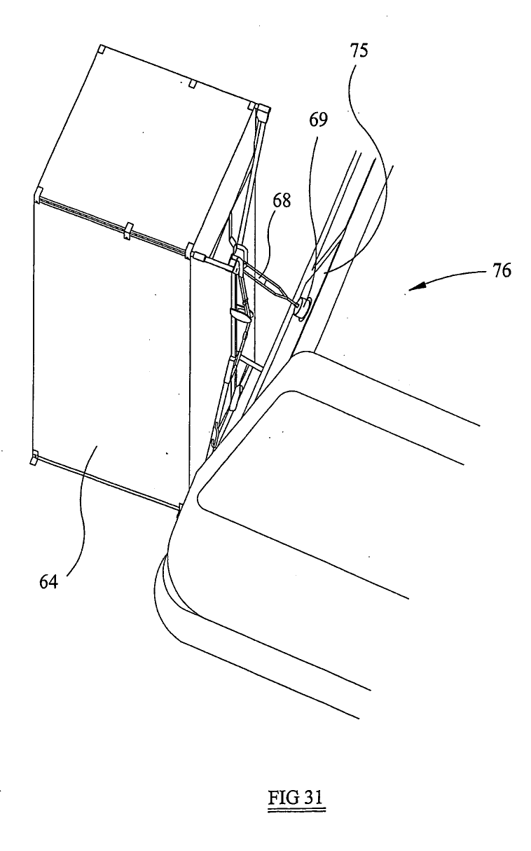

FIG. 29 is a perspective view from the opposite side of the support frame of FIG. 28,

FIG. 30 is a perspective view of the erected cubicle device of FIG. 27 temporarily attached to a vehicle, and

FIG. 31 is a perspective view from above of the cubicle device of FIG. 30 temporarily attached to said vehicle.

Although, as will be described hereinafter, the present invention has particular applicability in the provision of a cubicle device to provide a portable toilet facility, the invention is not limited thereto, and includes within its scope, a temporary cubicle device in general.

To this end FIG. 1 shows the general construction of such a cubicle 10 in its assembled, i.e. unfolded, state. Typically the assembled cubicle device 10 would be of square or rectangular shape, for example 650 mm×700 mm in cross-section and 1850 mm high to enable most people to carry out the required actions comfortably. The cubicle device will generally be made of a light, waterproof, easily foldable material, such as a tent fabric. It would, in one embodiment, be fitted with a double-sided zip and be washable. An important feature of the cubicle device is that it must be of a construction which allows it to be erected/assembled very quickly, for example within less than one minute.

The cubicle device shown in FIG. 1 is shown fitted with an upper disposable plastic cover 11, and an optional lower disposable plastic cover 12, each being held in place with press-studs 13 or the like. In the embodiment shown, the upper cover is translucent to allow light into the cubicle, and this cover also keeps the rain off a user and out of the cubicle device. The optional lower cover 12 serves two functions. Firstly whether used as a portable toilet, or merely as a cubicle, for example for changing clothes, the user's feet and clothes can be kept clean and dry if the unit is used in wet or muddy conditions. Later a dirty or soiled ‘groundsheet’ can be disposed of and a new one quickly fitted. Secondly when the cubicle is used as a portable toilet, the lower cover allows both the toilet itself and the user to provide an ‘anchor’ weight to steady the unit in any winds.

The actual toilet unit itself does not form part of the present invention, and a user can supply his or her own, or make use of the lightweight, foldable unit if this is supplied with the cubicle device. This will be referred to in respect of FIGS. 23 to 25 hereinafter. It is envisaged that the unit supplied with the cubicle device will make use of biodegradable plastic bags made of maize starch or similar.

The embodiment of the invention shown in FIGS. 2 to 5 is one version of a portable toilet which is permanently attached to a vehicle 14.

In this embodiment the vehicle 14 is of hatchback form, and as will be described, the cubicle device, when not in use, is stowed in the boot of the vehicle, this constituting a first state of the cubicle device. In this embodiment, part of the cubicle device 15 is thus permanently attached to a part of the vehicle and relative to the further embodiment to be described in relation to FIGS. 6 to 10 is the fastest to set up, in use. It is thus appropriate for more frequent use than the later option to be described.

As shown in FIGS. 2 to 5, the cubicle device 15 is formed with an upper square or rectangular support frame 16 from which material 17 of the cubicle device depends, the material being attached to the frame 16 in any convenient manner. As shown best in FIGS. 2 and 4, material at the rear of the cubicle is attached to the vehicle within its boot, and the material at respective opposite sides of the cubicle device is shaped so as to extend over the rear bumper of the vehicle and then to the ground, in its assembled state, at the outside of the rear of the vehicle. Part of the support frame 16 adjacent the interior of the rear door or tailgate of the vehicle is attached thereto by any convenient pivot means 18.

As shown in FIG. 3, included in this embodiment of the cubicle device is a toilet seat 19 which is permanently mounted to the floor of the vehicle boot, this providing a firm anchor for the structure. The toilet seat can be used with any suitable receptacle, for example a biodegradable plastic bag as mentioned above. As shown in FIG. 5, this seat can be pivoted, i.e. opened out, after the cubicle device has been fully assembled, so that it lies within the cubicle exteriorly of the vehicle to enable the toilet to be used.

Accordingly with reference to FIGS. 2 to 5, it can be seen that when the rear door or tailgate of the vehicle 14 is opened and lifted up, folded material 17 of the cubicle device 15 is drawn out of the boot. Once the rear door or hatchback is fully open, the support frame 16 will have been lifted, in the direction of the arrow shown in FIG. 2, to the position shown in FIG. 3. The support frame 16 is then moved to the horizontal position shown in FIG. 4, in which it is held by a spring and catch mechanism, or by any other suitable means. This movement of the frame to the horizontal position further unfolds the material 17 secured to the frame 16, so that the fully assembled state of the cubicle device 15 is then reached as shown in FIG. 4 with the material depending from the support frame 16 defining a completely closed cubicle.

As mentioned above, it is intended with this embodiment that after the cubicle has been fully assembled/erected, the toilet seat 19 is opened out in the direction of the arrow shown in FIG. 5 so that it is positioned within part of the cubicle device which is situated outside of the vehicle.

Access to the cubicle device is via a suitable opening 20 in the front or one side of the material of the cubicle device 15. As shown in FIG. 4, the opening 20 is in one side of the assembled cubicle device 15. The opening can be provided with a zip, or can be released and secured by the use of ‘Velcro’®. As described with the cubicle device of FIG. 1, the cubicle device 15 can have disposable plastic sheets fitted at the top and bottom thereof respectively, these being attached by press-studs or any similar means. Thus as stated above, these sheets can be changed after use in muddy conditions.

The embodiment of the invention shown in FIGS. 6 to 10 is a variation on that shown in FIGS. 2 to 5, in that although the cubicle device 21 is still associated with a vehicle, it is now mounted, when stowed, on the roof of the vehicle, as shown in FIG. 6, instead of being stowed in the boot thereof. Thus here the vehicle could be other than one with a hatchback, i.e. a conventional four door booted vehicle. This version of a car toilet shown in FIGS. 6 to 10 may be used when a more permanent version is required, but where the owner of the vehicle wants to retain full use of the boot. Although erection of the cubicle device 21 may take more time than erection of the cubicle device 15, in the first embodiment, it is believed that it would be quicker than the ‘stick-on’ version to be described hereinafter in relation to FIGS. 18 to 22.

In the embodiment shown in FIGS. 6 to 10, the stowed cubicle device 21 is mounted on the roof of the vehicle in substantially the same manner as for a normal car roof rack. The exact manner of fixing will depend upon the roof design of the vehicle in question. The stowed device 21 may incorporate the mechanism enabling it to be locked and kept so when not in use. In one embodiment access to the lock will normally be on the driver's side.

As shown in FIGS. 6 and 7, the cubicle device 21 incorporates an upper square or rectangular canopy 22, to which is hinged a lower side part 23. As shown best in FIG. 7, the canopy 22 is fixed by a linkage 24 at respective opposite sides thereof to respective spaced rails 25 fixed on the vehicle roof. A catch (not shown) secures the canopy 22 to the lower side part 23. Each of these components of the cubicle device 21 has some depth, so that, as shown in FIG. 7, it is possible to stow between these two components in their closed state shown in FIG. 6, a folded toilet seat 26, this, for example, being held fixed to the interior of the side part 23 by any suitable fixing means.

Accordingly by pulling the closed assembly of the canopy 22 and lower side part 23 in the direction of the arrow shown in FIG. 6, this assembly can be drawn forwards and upwards to a suitable position. This pulling causes the assembly to go over ‘top dead centre’ and then to stop in a stable position. When the catch mentioned above between the canopy 22 and lower side part 23 is released, the lower portion 23 can be opened to gain access to the folded seat 26, with this side part 23 lying at the side of the vehicle, depending from the horizontal canopy which extends outwardly at the exterior of the side of the vehicle.

As shown in FIG. 8, it is possible, once the lower side part 23 has been released from the canopy 22, to remove the folded toilet seat 26, and then to unfold it and position it below the canopy 22 so that it is in place, at least approximately, for when the cubicle device 21 is fully assembled. Its fully assembled state is that shown in FIGS. 9 and 10, and to achieve this state, the cubicle device material, which has been folded, for example, into the canopy 22, is released to assume the shape shown in FIG. 9, depending from the canopy shape 22, in the manner of lowering a window blind. When the FIG. 9 state is reached, the cubicle device 21 is then ready for use. As with the first embodiment, access to the cubicle device 21 via, for example, a side thereof, is via a zipped or ‘Velcro’® opening (not shown). Again the base of the cubicle device may be fitted with a disposable plastic sheet, which may be changed after use in muddy conditions. The material 27 of the cubicle device would generally be the same as that described in relation the cubicle device shown in FIG. 1.

The embodiment of the invention shown in FIGS. 18 to 22 is one where there is no permanent attachment of the cubicle device 28 to a vehicle 29, but only a temporary attachment. Accordingly this version of the car toilet has the most general application for ‘emergency’ use. Whilst it can be set up reasonably quickly, it is intended as a method of last resort.

The cubicle device 28 here includes a support frame 30 which is used not only to temporarily attach the cubicle device to a vehicle, but also provides the main structure of the cubicle device and defines the shape thereof. The support frame, which is shown in FIG. 11, for clarity, without the attached material of the cubicle device, comprises a pair of main link arms 31, 32 which are pivoted together at their respective lower ends, at which a suction pad 33 is disposed. Approximately half-way along their length, the arms are provided with pivotally connected stabilising arms 34, 35 respectively, at the end of which are respective means for engagement with a vehicle roof, as will be described in detail in relation to FIGS. 15 to 17.

At the ends of the main arms remote from the suction pad 33 are respective brackets 36, 37, at which respective support bars 38, 39 are pivoted, these bars carrying the material 40 of the cubicle device 28.

As shown in FIGS. 11 and 14, an unfolding or opening of the support frame 30 causes the support arms or bars 38, 39 to move from their folded position shown in FIG. 11, where they lie in close proximity to the main arms 31, 32, to a position shown in FIGS. 12 and 13 where they have pivoted through 90° from their folded position to lie, in use, horizontal, and normal to the plane of the remainder of the frame 30. From FIG. 14 it can be seen that this pivoting is effected by means of linkage rods 41, 42 respectively which themselves are connected from the brackets 36, 37 to respective links 43, 44 which have one of their respective ends at the main arms 31, 32 and are pivoted together at their respective other ends by a pivot 45.

The support frame 30 folds to a compact size, and is arranged to facilitate the folding with it of the material 40 of the cubicle device 28, so that the support frame 30 and material 40 can be folded to a compact size and, for example, stowed in a manageable sized carrying bag. The support frame 30 is very light, for example weighing approximately 1500 g. The support frame is constructed so that when the main arms 31, 32 are pulled apart in the direction of the arrows shown in FIG. 11, the frame work opens fully, as shown in FIG. 12, to support the canopy, with the support bars 38, 39 which carry the material 40 moving to their spaced, parallel, horizontal position shown in FIG. 12 so that the material assumes the square or rectangular shape defined by said bars. In practice, it is generally necessary for a user of the device manually to unfold the material 40 from around the support frame to assemble the cubicle device into its FIG. 12 state, the support frame being held during this operation by the person setting up the cubicle device.

As shown in FIGS. 18 to 20, it is intended that in one embodiment of the invention the assembled cubicle device 28 is temporarily attached to a vehicle, and this can be effected in various ways. In the embodiment illustrated, each of the stabilising arms is provided at its free end with means for engaging the vehicle roof. FIG. 15 shows a projection 46 engaged in a ‘well’ 47 of the vehicle roof, whilst FIG. 16 shows the projection 46 engaged with a roof bar 48 of the vehicle. As can be seen from FIGS. 15 to 17, the end of each stabilising arm can be adjustable, for example by way of a telescopic arrangement, so that the extreme separate end of each arm can be rotated to make use of a magnet 49 instead of the projection 46. Accordingly FIG. 17 shows the alternative fixing means at the end of the stabilising arm. The magnet 49 would normally be strong and is mounted so that it can ‘float’ and so adjust to any roof angle. Clearly this is only applicable to cars with steel roofs, and, as will be described, an alternative fixing is required for temporary attachment of the cubicle device to an aluminum roof.

FIGS. 18 and 19 show the cubicle device 28 set up in its working position. The stabilising arm magnets 49 provide a grip on the roof of the vehicle 29, whilst the suction pad 33 anchors the support frame 30 to a rear side window of the vehicle. In FIG. 20, the cubicle device 28 is cut away to show the normal position of a toilet seat 50 used within the cubicle device 28. It will be appreciated that this set-up could equally be provided at the opposite side of the vehicle.

If a magnetic attachment is not possible, for example where the body to which the cubicle device is to be temporarily attached is of aluminum, the magnets 49 can be replaced with a single main suction unit 51 shown in FIG. 21, and in greater detail in FIG. 22. Here it could be arranged that the support frame is supported by respective rubber pads, one of which 52, is shown in FIG. 21. Given that the cubicle device when incorporating the unit 51 is somewhat different from cubicle device 28, it will be noted that in FIGS. 21 and 22, the cubicle device has been denoted by the numeral 28a.

With regard to the embodiments described and shown where the cubicle device is permanently attached to the vehicle, it will be understood that in either case the cubicle device could be retrofitted to an existing vehicle.

With the arrangement where the cubicle device is only temporarily attached to a vehicle or other structure, the window pad anchors the structure in place, whilst the two stabilising arms act as supports. However alternatively it will be possible to support entirely off the roof of the vehicle or from the side thereof. Where a suction pad or suction cup is used, this can be arranged to be angled to suit the glass of the vehicle accordingly. With regard to the roof-mounted embodiment, it is envisaged that it may be possible to arrange for this to be remotely controlled, for example for a wheelchair user, so that on operation of a remote controlled unit the stages in the assembly of the cubicle device 21 shown in FIGS. 6 to 10 would occur automatically.

FIGS. 23 and 24 show, in detail, a toilet seat 53 of the same form as the seats 26 and 50 shown in FIGS. 8 and 20 respectively. It can be seen that the seat 53 is of generally conventional pivoted folding form, but has an opening in its seat part 54. It is intended that this seat could be used with a biodegradable plastic bag 55 such as that shown in FIG. 25. However if a user already has a suitable portable toilet unit, this could be used instead. FIG. 25 shows how the bag 55 is set up in the seat. No fixing is required. The proposed bags would be made from corn or maize starch and are compostable in approximately forty-five days. Preferably used bags are buried.

A particular advantage of the invention is that the cubicle allows a user space to stand up to prepare. This is considered to be much more convenient than prior art arrangements where the toilet has been provided wholly within a vehicle. Moreover a cubicle device of the invention can be used without a vehicle, for example as a free-standing unit for swimmers, surfers, etc. who need to change clothes in a public place. As far as the use of the cubicle device as a portable toilet is concerned, it is considered that the invention conveniently and efficiently meets the requirements set out in the introduction, particularly in relation to IBD sufferers.

An improved form of support frame 56 for another embodiment of a cubicle of the invention is shown in FIG. 26 in an erected state, but without the cubicle material 40, whilst in FIG. 27 the complete erected cubicle is shown. The support frame folds to a folded/stowed position, as shown in FIGS. 28 and 29, the material not being shown for clarity.

The support frame 56 of FIGS. 26 to 29 is made up substantially of a pair of support frames parts 57, each like the support frame 30 of FIG. 11, arranged on an elongate support member 58, which, is vertically centrally upright at one closed side of the cubicle in its erected state. The support member 58 can be folded in half from its erected state about a central horizontal split 58a, in use, and folding together respective link arms of the two support frames 57 causes the two folded pairs of link arms to slide along the support member 58 towards said central split. The support member can be of bar or tube.

Since the upper and lower parts (in erected form) of the support frame are largely identical, only the upper one will is described in any detail.

Like the support frame 30, the upper support frame part 57 comprises a pair of link arms 59, 60 respectively, at the respective free ends of which are pivotally connected support arms 61, 62. The support arm 61 carries material at the top of the cubicle along the openable side 63 thereof, and the support arm 62 carries material along the top of an opposite closed side 64, the arms 61 and 62 being parallel to each other when the cubicle is erected. They can fold down to lie parallel with and nest adjacent their associated link arms 59, 60 respectively, as shown in FIGS. 28 and 29. In their erected state, they are normal to said arms.

The arms 59, 60 are pivotally connected by respective links 65, 66 to the end of the support member 58 and the respective ends of the link arms 59, 60 remote from the support arms 61, 62 are pivotally connected inside a cover 67 which is slidable on the support member. Projecting from the support member 58 in the opposite direction to the support arms 61, 62 is an arm 68 carrying a suction pad 69, of the same form as pad 33. A handle 70 is provided at the outside of the link arm 60.

The lower part of the complete support frame 56, formed by lower support frame part 57 is substantially the same as the upper support frame part 57, but does not have the arm 68 and suction pad 69. It does however include a plate 71 secured centrally to the lower end of the support member 58 at its junction with the links 65, 66. The plate 71 protects the lip of the suction pad 69, as shown in FIGS. 28 and 29, when the support frame 56 is folded and stored.

At one side of the support member 58, at its centre split 58a, there is fixed a casing member 72 to which the upper and lower halves of support member 58 are connected in order to allow them to be nested as shown in FIGS. 28 and 29 when the member 58 is folded in half for dis-assembly and stowing the cubicle. Respective over-centre toggles 73, 74 of any convenient form are provided between the casing member 72 and the respective upper and lower covers 67. In the erected state of the cubicle, the toggles are activated to rigidify the erected cubicle.

The erected form of the cubicle is shown in FIG. 27 and this is foldable to a folded and stowed state for storage and transport, desirably in a carrying bag or like carrier. The folded support frame (without material 40) is shown in FIGS. 28 and 29.

From its stored state, a user removes the device from its bag and holds it by the handles 70, allowing the material 40 to hang freely. By holding the handles, the user then opens the device as far as possible to unfold member 58 and pivot the pair of link arms apart. This causes the covers 67 and link arms to move along the member 58 and causes the links 65, 66 to lock the link arms in their pivoted apart state. The support arms can then be pivoted through 90°. The material 40 will now have been formed into the cubicle shape, before lastly the toggles 73, 74 are over-centred to lock the cubicle rigidly.

Unfolding of the cubicle is the reverse and with the support arms folded to the link arms, the links folded to the link arms, the covers 67 having slid along the support member 58, and the member having been folded in half, the structure takes the neat folded form of FIGS. 28 and 29.

FIGS. 30 and 31, like FIGS. 18 to 20, shows the erected cubicle temporarily attached to a vehicle. The suction cup 69, which can be unfolded via its pivoted arm 68, is attached to a window 75 of the vehicle 76. The cubicle can have an opening 77 in the side 63 in the form of a zipper, a Velcro® flap or the means.

All other components and accessories for the cubicle of FIGS. 27, 30 and 31, can be as for the earlier described embodiments.

1.-48. (canceled)

49. A temporary cubicle device comprising a foldable support frame having attached to part thereof foldable non-transparent material, the support frame and material being movable between a first, folded state for stowage of the device, and a second, unfolded state in which the unfolded support frame defines at least part of the shape of the cubicle device automatically in its assembled state in which said material is unfolded.

50. A cubicle device as claimed in claim 49, wherein the support frame includes a pair of support arms to which said material is attached.

51. A cubicle device as claimed in claim 50, wherein when said support frame is unfolded, the support arms are automatically moved to lie normal to a main part of the support frame.

52. A cubicle device as claimed in either claim 49 wherein the support frame includes a linkage comprising a pair of main link arms which respectively pivotally carry said support arms at free ends thereof, the main link arms being foldable towards one another to fold the support frame and away from one another to unfold the support frame, the main link arms being pivotally connected to respective links which have their respective ends spaced from the main link arms connected by a common pivot.

53. A cubicle device as claimed in claim 52, wherein on folding the support frame from its unfolded to its folded state, said main link arms are folded together along with said links folding together, and said part of the support frame can slide along a support member of the support frame.

54. A cubicle device as claimed in claim 53, wherein on folding the support frame from its unfolded to its folded state, said main link arms are folded together along with said links folding together, and said part of the support frame can slide along a support member of the support frame.

55. A cubicle device as claimed in claim 54, having a pair of said linkages at the top and bottom thereof, said parts of the support frame to which upper and lower pairs of main link arms are respectively pivotally connected being slidable on said support member.

56. A cubicle device as claimed in claim 55, wherein the support member is foldable about its centre so that in the folded state of the support frame, the pair of linkages lie aside each other in a folded state.

57. A cubicle device as claimed in claim 55, wherein the respective upper and lower toggles are actuatable in the unfolded state of the support frame to maintain the support member erect so as thereby to rigidify the support frame.

58. A cubicle device as claimed in claim 55, wherein one main link arm of each linkage is provided with a handle for facilitating folding and unfolding of the linkage, in use.

59. A cubicle device as claimed in claim 52, wherein the linkage includes an arm carrying a suction cup for attaching the erected cubicle device, in use, to a vehicle.

60. A cubicle device as claimed in claim 59, wherein the arm is foldable.

61. A cubicle device as claimed in claim 49, wherein the support frame includes foldable stabilising arms for engagement, in use, with a vehicle roof, when the erected cubicle device is temporarily attached to a vehicle.

62. A cubicle device as claimed in claim 13, wherein the stabilising arms have respective magnets at their free ends for attachment to said vehicle roof.

63. A vehicle having attached to a part thereof a temporary cubicle device which is normally in a first, stowed state in or on the vehicle, but which upon manipulation by a user can assume an assembled state automatically, at least partly, in which at least a part thereof is at the exterior of the vehicle.

64. A vehicle as claimed in claim 63, wherein the frame is held horizontal by a spring and catch mechanism.

65. A vehicle as claimed in claim 63, including a toilet seat attached to a floor of the vehicle boot.

66. A vehicle as claimed in claim 65, wherein the toilet seat can be moved from a first stowed position where it is wholly received in the boot, to a second, in use, position where it is within the assembled cubicle.

67. A vehicle as claimed in claim 66, wherein the toilet seat can be pivoted from its first to its second position.

68. A vehicle having the cubicle device roof mounted and capable of being drawn forward to a stable position, wherein with the canopy in said stable position, operation of a catch releases from the underside of the canopy part a lower side part of the cubicle device, which depends from the canopy part at said side of the vehicle.

69. A vehicle as claimed in claim 68, wherein a toilet seat is stowed at said lower side part.

70. A vehicle as claimed in claim 68, wherein once the canopy part is in said stable position and said lower side part is released, non-transparent material attached to the canopy part can, in use, be released from its folded state so as to depend therefrom to reach the ground.
